(19) United States
(12) Patent Application Publication
(10) Pub. No.: US 2013/0115922 A1
(43) Pub. Date: May 9, 2013

(54) MOBILE PHONE, STORAGE MEDIUM AND METHOD FOR RESPONDING TO VOICE SYSTEM USING THE MOBILE PHONE

(71) Applicants: CHO-HAO WANG, Tu-Cheng (TW); KUAN-LIN WU, Tu-Cheng (TW)

(72) Inventors: CHO-HAO WANG, Tu-Cheng (TW); KUAN-LIN WU, Tu-Cheng (TW)

(73) Assignee: HON HAI PRECISION INDUSTRY CO., LTD., Tu-Cheng (TW)

(21) Appl. No.: 13/452,965

(22) Filed: Apr. 23, 2012

(30) Foreign Application Priority Data
Nov. 8, 2011 (TW) 100140649

(51) Int. Cl. H04W 4/12

(52) U.S. Cl. 455/412.1

(57) ABSTRACT

In a method for responding to a voice system using a mobile phone, a physical button of the mobile phone is predefined as a trigger button. When the mobile phone makes a phone call to a provider, voice messages of the provider are recorded and stored in a storage system of the mobile phone. Speech of a user of the mobile phone is recognized, a response message is acquired from the recognized speech of the user and the response message is input to the mobile phone while the trigger button keeps being pressed for a predetermined time. The voice messages stored in the storage system is recognized, a response message is acquired from the recognized voice messages, and the response message is input to the mobile phone when the trigger button is clicked.

### BACKGROUND

1. Technical Field

Embodiments of the present disclosure relate to the field of telecommunications, and more particularly to a mobile phone, a storage medium and a method for responding to a voice system using the mobile phone.

2. Description of Related Art

When a user accesses a voice system using a mobile phone, the user may use a keyboard of the mobile phone to input a response message according to prompt of the voice system, for responding to the voice system, to acquire desired information, such as a phone bill. However, if the user is not familiar with the arrangement of the keyboard of the mobile phone, it is inconvenient for the user to input the response messages to respond to the voice system when the user hears voice messages of the voice system at the same time.

### BRIEF DESCRIPTION OF THE DRAWINGS

FIG. 1 is a block diagram of one embodiment of a mobile phone including a voice responding system.

FIG. 2 is a flowchart of one embodiment of a method for responding to a voice system using the mobile phone of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

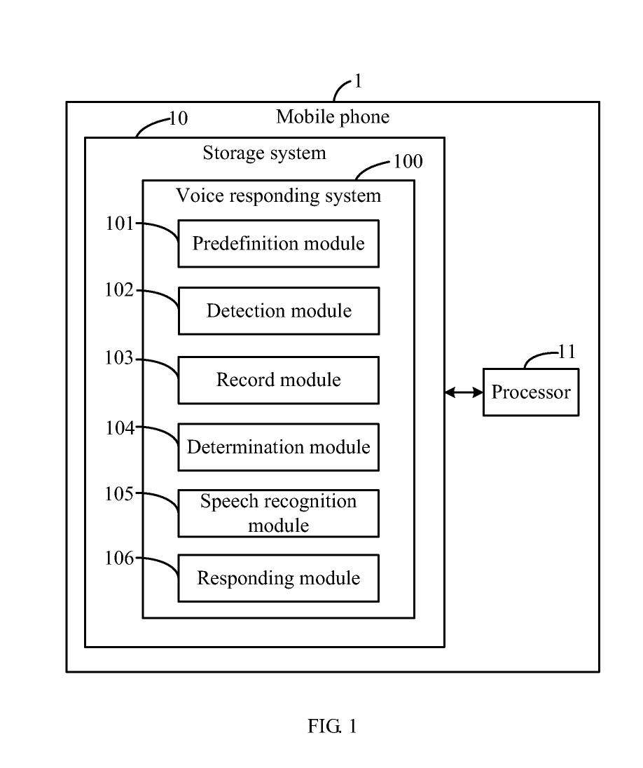

FIG. 1 is a block diagram of one embodiment of a mobile phone 1 including a voice responding system 100, which is used for responding to a voice system that is accessed by the mobile phone 1. For example, a user may call a voice system of a communications service provider to query an account balance of the mobile phone 1. In the embodiment, the mobile phone 1 further includes a storage system 10, at least one processor 11, and one or more physical buttons, such as camera buttons or power buttons. FIG. 1 is just one example of the mobile phone 1 that can be included with more or fewer components than shown in other embodiments, or have a different configuration of the components.

In the embodiment, the user can predefine one of the physical buttons as a trigger button using the voice responding system 100. For example, if a camera button of the mobile phone 1 is predefined as the trigger button, the trigger button cannot be used to take photos when the mobile phone 1 is making or receiving a phone call. The trigger button is configured for triggering the voice responding system 100 to respond to the voice system.

When the mobile phone 1 accesses the voice system, the voice responding system 100 can respond to a phone call or voice messages sent from the voice system according to the pressing of the trigger button by the user. For example, the user can click the trigger button when the user hears that the voice system outputs a desired response message, such as “1”. The voice responding system 100 recognizes the response message from the voice system and inputs the recognized response message to the mobile phone 1 to simulate a keyboard input for responding to the voice system. In another example, if the user presses the trigger button for a predetermined time when the user hears that the voice system outputs the response message, the user may speak the response message to the mobile phone 1 while the trigger button keeps being pressed. The voice responding system 100 recognizes the response message from speech of the user, and inputs the recognized response message to the mobile phone 1 to simulate a keyboard input for responding to the voice system.

In one embodiment, the storage system 10 may be a random access memory (RAM) for temporary storage of information, and/or a read only memory (ROM) for permanent storage of information. In other embodiments, the storage system 10 may also be an external storage device, such as a hard disk, a storage card, or a data storage medium. The at least one processor 11 executes computerized operations of the computing device 1 and other applications, to provide functions of the mobile device 1.

The voice responding system 100 may be in form of one or more programs stored in the storage system 10 and executed by the at least one processor 11. In the embodiment, the voice responding system 100 may include a predefinition module 101, a detection module 102, a record module 103, a determination module 104, a speech recognition module 105, and a responding module 106. The module 101-106 may comprises a plurality of functional modules each comprising one or more programs or computerized codes that can be accessed and executed by the at least one processor 11. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The predefinition module 101 predefines one of physical buttons of the mobile phone 1 as a trigger button. For example, the predefinition module 101 can predefine a camera button of the mobile phone 1 as a trigger button for responding to the voice system according to user's input. Furthermore, the predefinition module 101 predefines a predetermined time, such as five seconds, according to the requirements of the user.

The detection module 102 continually detects whether the trigger button is pressed when the mobile phone 1 makes a phone call to a provider.

The record module 103 records voices messages of the provider when the mobile phone 1 makes the phone call, and stores the recorded voice messages in the storage system 10 in real-time. If the mobile phone 1 makes the phone call to the voice system, the provider of the phone call is the voice system.

The determination module 104 calculates how long the trigger button has been pressed when the trigger button is pressed, and continually determines whether the pressing on the trigger button lasts for the predetermined time.

The detection module 102 further detects whether the trigger button is released when the pressing on the trigger button does not last for the predetermined time.

The record module 103 stops recording the voice messages of the provider, clears the recorded voice messages from the storage system 10, and triggers the speech recognition module 105 when the pressing on the trigger button lasts for the predetermined time.

The speech recognition module 105 recognizes speech of the user of the mobile phone 1 and acquires a response message from the recognized speech of the user while the trigger button keeps being pressed. The response message from the recognized speech of the user may include numbers or symbols on a keyboard of the mobile phone 1, such as “#” or “*”.

The record module 103 further stops recording the voice messages, and triggers the speech recognition module 105 when the trigger button is released and the pressing on the trigger button does not last for the predetermined time.

The speech recognition module 105 further recognizes the recorded voice messages in the storage system 10, and acquires a response message from the recognized voice messages. The recognized voice messages may include words, numbers or symbols on the keyboard of the mobile phone 1. The response message from the recognized voice messages may be a last number or a last symbol of the recognized voice messages, or a last combination of a number and a symbol of the recognized voice messages. For example, if the recognized voice messages is “for balance query, press ‘1’, to change the password, press ‘2’, for assistance, press ‘3’”, the speech recognition module 105 acquires the last one number “3” of the recognized voice messages as the response message.

The responding module 106 inputs the acquired response message from the recognized voice messages or the recognized speech of the user to the mobile phone 1 to simulate a keyboard input. The responding module 106 further triggers the record module 103 to clears the recorded voice messages from the storage system 10, and restarts recording of the voice messages.

The record module 103 further stops recording the voice messages, and clears the recorded voice messages from the storage system 10 when the mobile phone 1 ends the phone call.

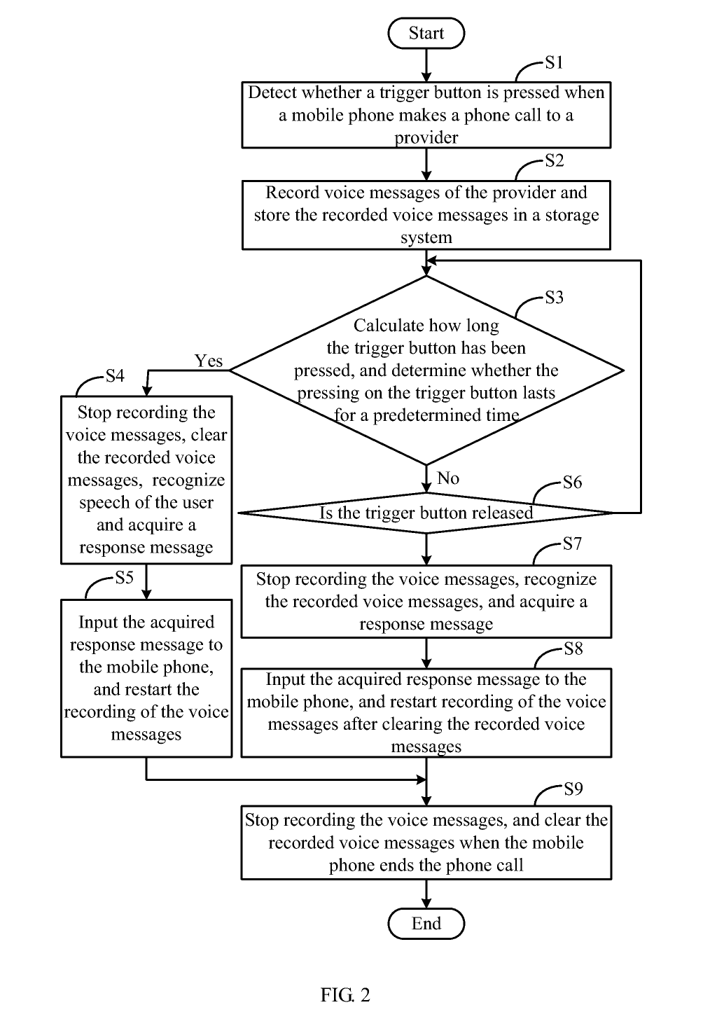

FIG. 2 is a flowchart of one embodiment of a method for responding to a voice system using the mobile phone 1 of FIG. 1. Depending on the embodiment, additional steps may be added, others removed, and the ordering of the steps may be changed.

Before step S1, the predefinition module 101 predefines one of physical buttons of the mobile phone 1 as a trigger button for responding to the voice system. In the embodiment, the predefinition module 101 may further predefine a predetermined time, such as five seconds, according to requirements of the user.

In step S1, the detection module 102 continually detects whether the trigger button is pressed when the mobile phone 1 makes a phone call to a provider.

In step S2, the record module 103 records voice messages of the provider, and stores the recorded voice messages in the storage system 10.

In step S3, the determination module 104 calculates how long the trigger button has been pressed when the trigger button is pressed, and determines whether the pressing on the trigger button lasts for the predetermined time. If the pressing on the trigger button lasts for the predetermined time, step S4 is implemented. If the pressing on the trigger button does not last for the predetermined time, step S6 is implemented.

In step S4, the record module 103 stops recording the voice messages of the provider, clears the recorded voice messages from the storage system 10, and triggers the speech recognition module 105. The speech recognition module 105 recognizes speech of the user of the mobile phone 1 and acquires a response message from the recognized speech of the user while the trigger button keeps being pressed. The response message from the recognized speech of the user may include numbers or symbols on a keyboard of the mobile phone 1.

In step S5, the responding module 106 inputs the acquired response message from the recognized speech of the user to the mobile phone 1 to simulate a keyboard input, and triggers the record module 103 to restart the recording of the voice messages of the provider.

In step S6, the detection module 102 detects whether the trigger button is released. If the trigger button is released, step S7 is implemented. If the trigger button is not released, the flow may return to step S3.

In step S7, the record module 103 stops recording the voice messages of the provider, and triggers the speech recognition module 105. The speech recognition module 105 recognizes the recorded voice messages in the storage system 10, and acquires a response message from the recognized voice messages. The response message from the recognized voice messages may be a last number or a last symbol of the recognized voice messages, or a last combination of a number and a symbol of the recognized voice messages.

In step S8, the responding module 106 inputs the acquired response message from the recognized voice messages to the mobile phone 1 to simulate a keyboard input. The responding module 106 further triggers the record module 103 to clear the recorded voice messages from the storage system 10, and restarts recording of the voice messages.

In step S9, the recording module 103 stops recording the voice messages, and clears the recorded voice messages from the storage system 10 when the mobile phone 1 ends the phone call.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile phone, comprising:
a storage system;
at least one processor;
one or more physical buttons;
one or more programs stored in the storage system and executed by the at least one processor, the one or more programs comprising:
a predefinition module that predefines a physical button of the mobile phone as a trigger button for responding to a voice system;
a record module that records voice messages of a provider when the mobile phone makes a phone call to the provider, and stores the voice messages in the storage system;
a determination module that calculates how long the trigger button has been pressed when the trigger button is pressed, and determines whether the pressing on the trigger button lasts for a predetermined time;
a speech recognition module that recognizes speech of a user of the mobile phone, and acquires a response message from the recognized speech of the user while the trigger button keeps being pressed, upon the condition that the pressing on the trigger button lasts for the predetermined time;
the speech recognition module that further recognizes the recorded voice messages in the storage system, and acquires a response message from the recognized voice messages, upon the condition that the trigger button is released and the pressing on the trigger button does not last for the predetermined time; and
a responding module that inputs the acquired response message from the recognized speech of the user or the recognized voice messages to the mobile phone.

2. The mobile phone of claim 1, the one or more programs further comprising:
a detection module that continually detects whether the trigger button is pressed or released when the mobile phone makes the phone call.

3. The mobile phone of claim 1, wherein the response message from the recognized speech of the user includes numbers or symbols on a keyboard of the mobile phone.

4. The mobile phone of claim 1, wherein the response message from the recognized voice messages is a last number or a last symbol of the recognized voice messages, or a last combination of a number and a symbol of the recognized voice messages.

5. The mobile phone of claim 1, wherein the responding module inputs the response message to the mobile phone to simulate a keyboard input.

6. The mobile phone of claim 1, wherein the record module further stops recording the voice messages, and clears the recorded voice messages from the storage system when the mobile phone ends the phone call.

7. A method for responding to a voice system using a mobile phone, the method comprising:
(a) predefining a physical button of the mobile phone as a trigger button for responding to the voice system;
(b) recording voice messages of a provider when the mobile phone makes a phone call to the provider, and storing the recorded voice messages in a storage system of the mobile phone;
(c) calculating how long the trigger button has been pressed when the trigger button is pressed, and determining whether the pressing on the trigger button lasts for a predetermined time;
(d) recognizing speech of a user of the mobile phone and acquiring a response message from the recognized speech of the user while the trigger button keeps being pressed, upon the condition that the pressing on the trigger button lasts for the predetermined time;
(e) recognizing the recorded voice messages in the storage system, and acquiring a response message from the recognized voice messages, upon the condition that the trigger button is released and the pressing on the trigger button does not last for the predetermined time;
(f) inputting the acquired response message from the recognized speech of the user or the recognized voice messages to the mobile phone.

8. The method of claim 7, further comprising:
continually detecting whether the trigger button is pressed or released when the mobile phone makes the phone call.

9. The method of claim 7, wherein the response message from the recognized speech of the user includes numbers or symbols on a keyboard of the mobile phone.

10. The method of claim 7, wherein the response message from the recognized voice messages is a last number or a last symbol of the recognized voice messages, or a last combination of a number and a symbol of the recognized voice messages.

11. The method of claim 7, wherein the response message is input to the mobile phone in to simulate a keyboard input.

12. The method of claim 7, further comprising:
stopping recording the voice messages and clearing the recorded voice messages from the storage system when the mobile phone ends the phone call.

13. A non-transitory storage medium storing a set of instructions, the set of instructions capable of being executed by a processor of a mobile phone, causes the mobile phone to execute a method for responding to a voice system, the method comprising:
(a) predefining a physical button of the mobile phone as a trigger button for responding to the voice system;
(b) recording voice messages of a provider when the mobile phone makes a phone call to the provider, and storing the recorded voice messages in a storage system of the mobile phone;
(c) calculating how long the trigger button has been pressed when the trigger button is pressed, and determining whether the pressing on the trigger button lasts for a predetermined time;
(d) recognizing speech of a user of the mobile phone and acquiring a response message from the recognized speech of the user while the trigger button keeps being pressed, upon the condition that the pressing on the trigger button lasts for the predetermined time;
(e) recognizing the recorded voice messages in the storage system, and acquiring a response message from the recognized voice messages, upon the condition that the trigger button is released and the pressing on the trigger button does not last for the predetermined time;
(f) inputting the acquired response message from the recognized speech of the user or the recognized voice messages to the mobile phone.

14. The storage medium of claim 13, wherein the method further comprises:
continually detecting whether the trigger button is pressed or released when the mobile phone makes the phone call.

15. The storage medium of claim 13, wherein the response message from the recognized speech of the user includes numbers or symbols on a keyboard of the mobile phone.

16. The storage medium of claim 13, wherein the response message from the recognized voice messages is a last number or a last symbol of the recognized voice messages, or a last combination of a number and a symbol of the recognized voice messages.

17. The storage medium of claim 13, wherein the response message is input to the mobile phone to simulate a keyboard input.

18. The storage medium of claim 13, wherein the method further comprises:
stopping recording the voice messages and clearing the recorded voice messages from the storage system when the mobile phone ends the phone call.
